(19) United States
(12) Patent Application Publication
(10) Pub. No.: US 2014/0220874 A1
(43) Pub. Date: Aug. 7, 2014

(54) RADIANT HEAT RAISED ACCESS FLOOR PANEL

(71) Applicant: Gary Meyer, Golden, CO (US)

(72) Inventor: Gary Meyer, Golden, CO (US)

(21) Appl. No.: 13/760,493

(22) Filed: Feb. 6, 2013

(51) Int. Cl. B60H 1/22

(52) U.S. Cl. CPC B60H 1/2225
USPC 454/159; 219/202

(57) ABSTRACT

A radiant heat raised access floor panel is provided. The panel includes a panel core. The core has four corner portions, four lateral edge portions, an upper load bearing surface, a lower plenum surface, a heating element, and an electrical connector in the lower surface adapted to connect to a pedestal head of a raised floor pedestal support system. A power and control circuit is in electrical communication with said connector and is adapted to variably and radiantly heat a predetermined lower occupied zone of an underfloor air distribution system.

### CROSS REFERENCE TO RELATED APPLICATIONS

Pursuant to 35 U.S.C. 119(e), applicant claims the benefit of U.S. Ser. No. 61/595,266, filed, pursuant to 35 U.S.C. 111(b), on Feb. 6, 2012.

### STATEMENT OF FEDERALLY SPONSORED RESEARCH

Not Applicable.

### BACKGROUND OF THE INVENTION

1. Field of Invention

The present invention relates to raised floor systems. In particular, it relates to a radiant heat raised access floor panel for temperature control of an individual occupancy zone of an underfloor air distribution system.

2. Description of the Related Art

Underfloor air distribution (UFAD) uses a raised floor to create an air distribution plenum to improve energy efficiency and modularity of design. UFAD uses stratified airflow to improve the ventilation effectiveness and indoor air quality of the interior space. Stratified airflow refers to the deliver of air at a low velocity near the floor, allowing the air to naturally rise to a ceiling return pulling contaminants and CO₂ away from occupants.

UFAD air distribution systems introduce air at the floor level, with return grilles located near the ceiling. The space is divided into two zones: an occupied zone extending from the floor to head level; and an occupied zone extending from the top of the occupied zone to the ceiling. The systems are designed to condition the lower occupied zone only. Temperature conditions in the upper zone are allowed to float above the normal comfort ranges, and to avoid occupant discomfort, air is introduced into the space between in a range of 56 F. to 68 deg. F.

UFAD systems fall into two general categories which are distinguishable from one another by the temperature and velocity profiles they create in the occupied space. The first type is a displacement ventilation system, and the second type is a hybrid underfloor system. Displacement ventilation systems deliver air at floor level into the space at very low velocity, typically less than 50 feet per minute. At this velocity, the air coming out of the diffuser can barely be felt, and the fresh air pools on to the floor. The system produces two distinct zones of air, one characterized by stratified layers of relatively cool and fresh air, the other by fairly uniform hot and stale air. The vertical flow profile in the lower zone can be generally described as upward laminar flow, or “plug floor”. The effect of the plug flow is to displace the hot stale air into an area well above the breathing level of the occupants, giving occupants the benefit of breathing significantly higher-quality air. This displacement effect is augmented by the presence of heat sources within the occupied space.

Access floors are constructed from a series of panels elevated above the original floor by pedestals located at the corner of each panel. The access floor creates an underfloor space through which power, network, and phone wires can be installed. With a modest expansion in the depth of the underfloor space, a plenum for distributing conditioned air can also be created. Access floor panels are available in four different materials: all-steel; concrete; aluminum; or wood. Concrete floor panels are used in offices and equipment rooms. They have an excellent rolling load performance and the panels are solid and free from any floor- or plenum-generated noise. They also have excellent grounding and electrical continuity. Wood-core panels are available as a lower-cost option for offices and equipment rooms. They are durable, quiet, and economical, but building codes do not allow them to be used with underfloor supply systems because they are combustible.

Raised floor panels are generally of a solid surface or of a perforated surface in order to allow air flow. In UFAD applications, the solid panels are used to provide a smoother working surface and greater strength than grills. The usual method to support a raised floor is to place a support pedestal under each corner of the floor panels. In a typical system, shown in FIG. 1, the support pedestal 18 is a vertically disposed rod having oppositely aligned, right-handed and left-handed, threads at each end, respectively. A first end of the support pedestal 18 is threaded into a pedestal head 13 which supports a corner of the floor panel 10, and a second end of the pedestal support 16 is threaded into a pedestal support base 12 which, in turn, is fastened to the subfloor. In this manner the pedestal support 16 operates as a turnbuckle so that by rotating the pedestal support a vertical adjustment of the pedestal head in relation to the subfloor is achieved. The pedestal heads 13 are connected in a matrix by stringers 11 which support the edges of the floor panel. Other designs disclose the use of an adjusting bold threaded on the pedestal support 16 for vertical adjustment of the pedestal support 16 in relation to the pedestal base 12. Again, the pedestal heads 13 support the panels 10 at their corners, and additional lateral support is achieved at the edges of the panels with the stringers 11. In a stringer system, the panels 10 and stringers 11 are attached to the pedestal heads 13 using screws. Further support is often provided with a matrix of lower horizontal stringers 14 connected to the pedestal bases 12.

Certain surveys have shown that a tenants' ability to control the temperature in their individual suite is the most important feature is evaluating their perception of a building. Thus, to make an immediate and positive impact on tenants' perception of a building, landlords and managers have focused on temperature-related functions by updating existing HVAC systems so that tenants can control the temperature in their individual suite(s). To this end, UFAD systems also improve flexibility and control. UFAD allows for easy diffuser reconfiguration in reaction to office occupancy and layout changes. Each diffuser can be equipped with personal comfort controls so that occupants can adjust the amount and direction of airflow in their space.

While the reconfiguration of diffusers for temperature control of an individual occupancy zone, in a UFAD system, offers some utility, a problem exists in the precision and accuracy of the temperature control using diffused air-flow. Thus, what is needed is a precise temperature personal comfort and control floor panel so that occupants can adjust the temperature of their individual occupancy zone in a UFAD system. The present invention satisfies these needs.

### BRIEF SUMMARY OF THE INVENTION

It is therefore an object of the present invention to provide a raised access floor panel adapted for precise temperature control of an individual occupancy zone in a UFAD system.

It is another object of the present invention to provide a radiant heat raised floor access panel.

To overcome the problems associated with the prior art and in accordance with the purpose of the present invention, as embodied and broadly described herein, briefly, a radiant heat raised access floor panel is provided. The panel includes a panel core. The core has four corner portions, four lateral edge portions, an upper load bearing surface, a lower plenum surface, a heating element, and an electrical connector in the lower surface adapted to connect to a pedestal head of a raised floor pedestal support system. A power and control circuit is in electrical communication with said connector and is adapted to variably and radiantly heat a predetermined lower occupied zone of an underfloor air distribution system.

Additional advantages of the present invention will be set forth in part in the description that follows and in part will be obvious from that description or can be learned from practice of the invention. The advantages of the invention can be realized and obtained by the method particularly pointed out in the appended claims.

### BRIEF DESCRIPTION OF THE SEVERAL VIEWS OF THE DRAWINGS

The accompanying drawings, which are incorporated in and which constitute a part of the specification, illustrate at least one embodiment of the invention and, together with the description, explain the principles of the invention.

FIG. 1 is a perspective view of a raised floor system for use in a UFAD system.

FIG. 2 is a perspective view of a preferred embodiment of the radiant heat floor panel in accordance with the present invention. This figure illustrates the use of a cable and strip heating element array with a membrane attached to the lower plenum surface of the floor panel, a.

FIG. 3 is an example of an H-stringer configuration, of an individual workspace, for running the power and control components of the radiant heat UFAD system in accordance with a preferred embodiment of the present invention.

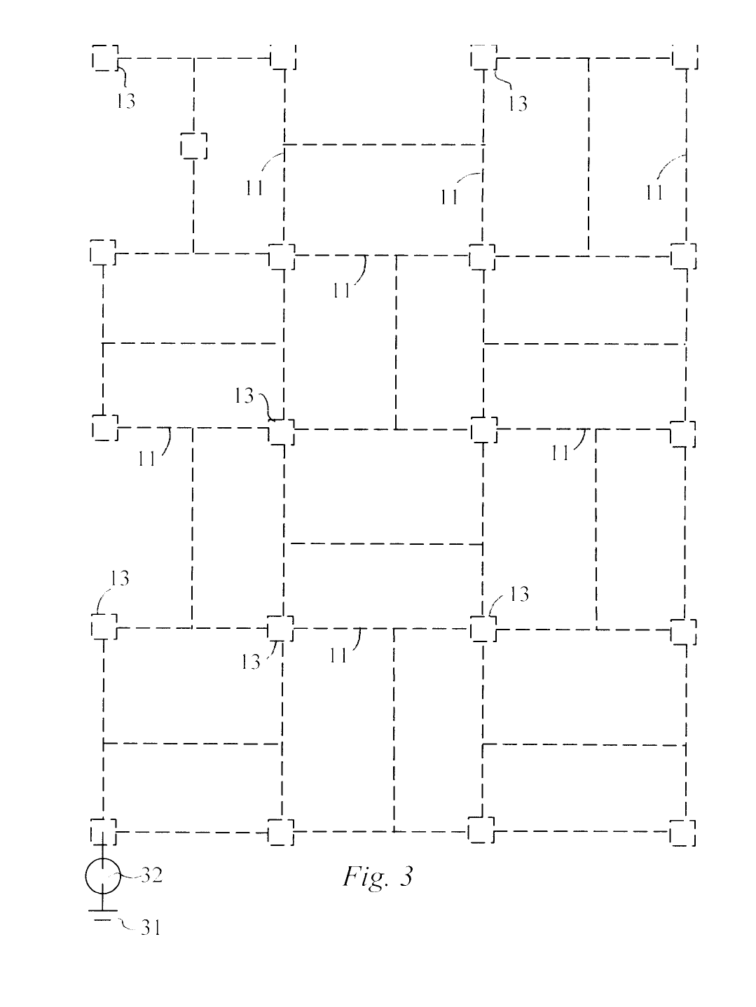

### DETAILED DESCRIPTION OF THE DRAWINGS

Unless specifically defined otherwise, all technical or scientific terms used herein have the same meaning as commonly understood by one of ordinary skill in the art to which this invention belongs.

Although any methods and materials similar or equivalent to those described herein can be used in the practice or testing of the present invention, the preferred methods and materials are now described. Reference now will be made in detail to the presently preferred embodiments of the invention, examples of which are illustrated in the accompanying drawings, wherein like numerals represent like features.

The invention provides a raised access floor panel 10 with heating elements 24 for use with a raised floor pedestal support 16 system having horizontal stringers 11, 14 and pedestal heads 13 adapted for connection and control of the heating elements 24. The floor panel 10 consists of a panel core 26, the heating element 24, in the form of an insulated wire array, and an electrical connector 22. The connector 22 is of any kind which is well known in the art, and is in electrical communication with a temperature control 32 and power cord 31. The temperature control 32 is desirably located in a convenient location adjacent to a cubicle to be individually-temperature-regulated. In this manner, variable and radiantly heating an individual cubicle workspace is achieved independent of the underfloor air temperature in a UFAD system.

The core 26 is desirably constructed as a solid-top raised access floor panel 10. Such panels 10 are well known and are typically constructed of a metal, wood, concrete, or a laminate material. The area of the panel 10 is preferably in a range of 0.37-1.49 meters². The panel 10 may, therefore, be configured in either a square or rectangular configuration. The panels 10 are adapted for deployment on a pedestal support system. As such, the floor panels 10 have four corner portions, four lateral edge portions, an upper load bearing surface, and a lower plenum surface. In the preferred embodiment, the lower surface of the panel 10 is adapted with a recess to receive a mat 25 including an array of heating elements 24.

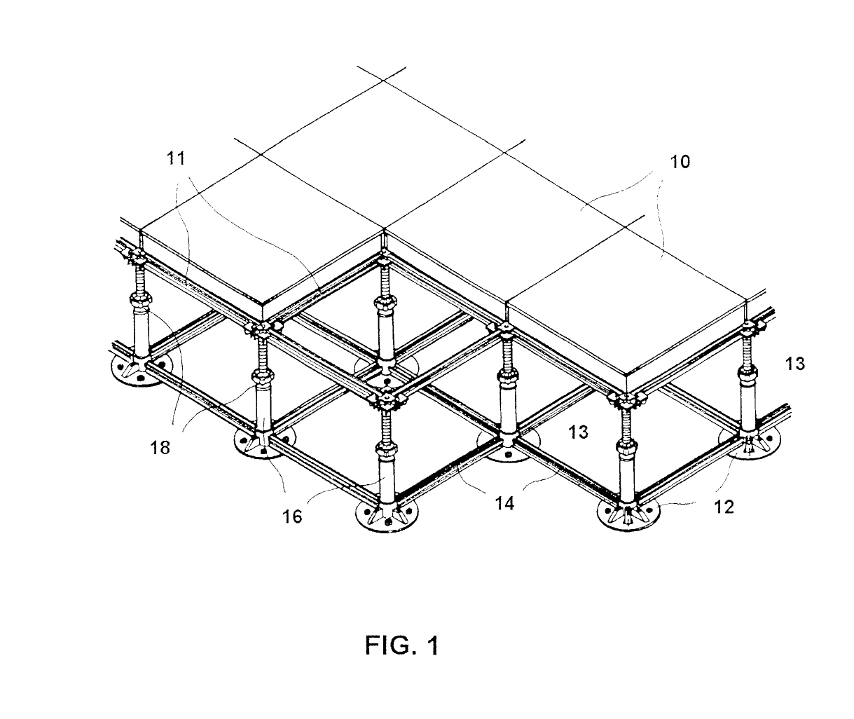

The pedestal support system is any one which is also well known in the art. As illustrated in FIG. 1, such systems are built-up constructions on the surface of a subfloor, and include a plurality of vertically extending pedestal supports 16. The pedestal supports 16 each have an upper end 18 connected to a pedestal support head 13, and a lower end 16 connected to a pedestal support base 12. A matrix of lower stringers 14 may, but need not, be providing connecting pedestal base 12 members. The pedestal support base 12 is attached to the subfloor of a building. The pedestal support heads 13 are each connected in a matrix orientation with a plurality of horizontal stringers 11. In this manner, the upper horizontal stringers 11 support the lateral edges of the panels 10, and the pedestal heads 13 support the corner portions of the panel 10. The pedestal heads 13 and stringers 11 are adapted for running the power and control cable to the connectors 22 located in the corner portions of the floor panels 10.

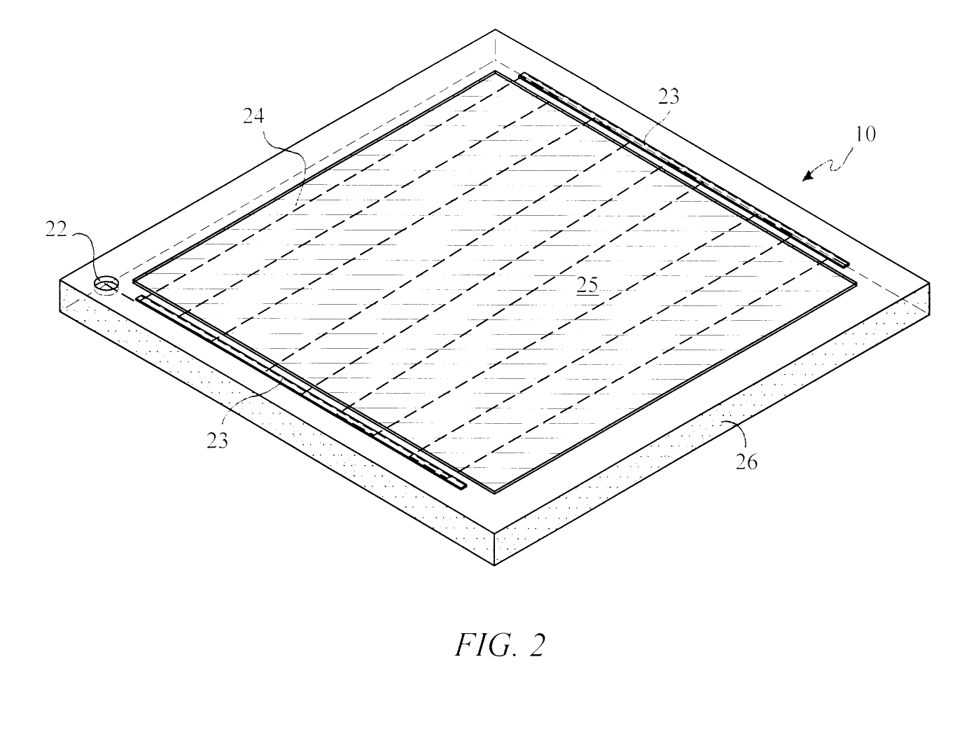

The heating element 24 is an electrical resistance element. The heating element 24 converts electricity into heat through the process of Joule heating. Electric current through the element encounters resistance, resulting in heating of the element 24. The heating elements 24 are preferably selected for a group of the most common wires consisting of the following classes: Kanthal (FeCrAl) wires; Nichrome 80/20 wire and strip 23; and Cupronickel (CuNi) alloys for low temperature heating. In the preferred embodiment, the electrical resistance heating element 24 is selected from a group of electrical systems, which are used only for heating, and employ non-corrosive, flexible heating elements 24 such as low voltage wire elements, including cables, pre-formed cable or wire mats 25, bronze mesh, and carbon films. One example of a mat 25 is made as an etched foil construction which is generally made from the same alloys as resistance wire elements, but is produced with a subtractive photo-etching process that starts with a continuous sheet of metal foil and ends with a complex resistance pattern. With the present invention, these elements are particularly desirably for use in precision heating applications with raised floors adaptable for use in the medical diagnostics, satellite, and aerospace applications. The etched foil is also desirably because it results in an ultra low profile resistance element so that they can be installed in a thermal mass of the panel, as an integral layer, or applied directly to the under surface of the floor panels (illustrated in FIG. 2) for connection to the electrical system. Finally, thin-films of positive thermal coefficient resistant materials are also adaptable for use with the present invention.

In a preferred embodiment the heating element 24 is a wire array in a mat 25 which is looped back and forth in contact with a metal conductive strip 23. The strip 23 may, but need not, be attached to the lower plenum surface of the panel 10 or press fit into a channel or groove, as shown in the drawing FIG. 2. In this manner, the panel 10 is formed with the channel or groove, the mat 25 is adhered to a preformed recess in the bottom surface of the panel 10, and the strip 23 is pressed into the channel. A free wire lead of the heating element 24 is the connected to the connector 22. The connector 22 is adapted to make a male/female connection with a press-fit connector in the pedestal head 13 of the pedestal support system. By way of example, with this application, the heating element 24 cable is looped back and forth on a 2″ to 3″ on center (“OC”) orientation. With this orientation, approximately 15 to 10 Watts/sq.ft. are generated for use in a range of high to low heat loss areas, respectively, depending on the desired use.

While a line voltage system is specifically contemplated for use with the present invention, in the presently preferred embodiment the heating element 24 is desirably constructed using low voltage technology. Power consumption of the electric system is not based on voltage but rather wattage output produced by the heating elements. The cable or wire may or may not be encased in an insulated jacket made of plastic (not shown).

While the present invention has been described in connection with the illustrated embodiments, it will be appreciated and understood that certain modifications may be made without departing from the true spirit and scope of the invention.

I claim:

1. A radiant heat raised access floor panel, comprising:
(a) a panel core having four corner portions, four lateral edge portions, an upper load bearing surface, a lower plenum surface, a heating element, and an electrical connector in the lower surface adapted to connect to a pedestal head of a raised floor pedestal support system; and
(b) a power and control circuit in electrical communication with said connector capable of variably and radiantly heating a predetermined lower occupied zone in an underfloor air distribution system.

2. The floor panel according to claim 1, wherein the heating element is a mat attached to the lower surface of the panel core.

3. The floor panel according to claim 1, wherein the heating element is a cable loop connected to a strip, wherein said strip is connected to the lower surface.

4. The floor panel according to claim 2, wherein the mat is an etched foil.

5. The floor panel according to claim 2, therein the mat is a thin-film.
